(19) United States
(12) Patent Application Publication
(10) Pub. No.: US 2026/0214230 A1
(43) Pub. Date: Jul. 23, 2026

(54) ENCODER AND ASSOCIATED ENCODING METHOD

(71) Applicant: Realtek Semiconductor Corp., HsinChu (TW)

(72) Inventors: Yi-Chen Tseng, HsinChu (TW); Wei Li, Suzhou City (CN); Weimin Zeng, San Jose, CA (US); Chi-Wang Chai, Santa Clara, CA (US); Wujun Chen, Suzhou City (CN)

(73) Assignee: Realtek Semiconductor Corp., HsinChu (TW)

(21) Appl. No.: 19/026,505

(22) Filed: Jan. 17, 2025

(51) Int. Cl. H04N 19/127; H04N 19/152; H04N 19/176; H04N 19/436

(52) U.S. Cl. CPC H04N 19/127; H04N 19/152; H04N 19/176; H04N 19/436

(57) ABSTRACT

The present invention provides an encoder including M core circuits. The M core circuits are configured to encode a first row of superblocks to a M-th row of superblocks of an image frame, and to update a cumulative distribution function (CDF) table during an encoding process of each superblock, where M is a positive integer greater than 1. The M core circuits are further configured to encode a (M+1)-th row of superblocks to a (2*M)-th row of superblocks of the image frame, and to update the CDF table during the encoding process of each superblock, wherein a first core circuit of the M core circuits uses the CDF table generated during the encoding process of a last superblock of the first row of superblocks to encode a first superblock of the (M+1)-th row of superblocks.

### BACKGROUND OF THE INVENTION

### 1. Field of the Invention

The present invention relates to a video encoder.

### 2. Description of the Prior Art

In bitrate control operations of an encoder, there are generally two types: constant bitrate (CBR) and variable bitrate (VBR). The constant bitrate refers to the encoder outputting image data with a fixed bitrate to facilitate transmission over a channel with limited bandwidth, while the variable bitrate means that the encoder adjusts the output bitrate according to the complexity of the input signal, in order to maintain the quality of the output image. However, due to the limited capacity of the buffer of the encoder, it is difficult to implement the constant bitrate and variable bitrate control methods in low-latency applications.

### SUMMARY OF THE INVENTION

One of the objectives of the present invention is to provide an encoder and related encoding method, which processes multiple rows of superblocks in parallel through multiple core circuits, in order to solve the problems described in the prior art.

According to one embodiment of the present invention, an

encoder comprising M core circuits is disclosed. The M core circuits are configured to encode a first row of superblocks to a M-th row of superblocks of an image frame, and to update a cumulative distribution function (CDF) table correspondingly during an encoding process of each superblock, where M is a positive integer greater than 1. The M core circuits are further configured to encode a (M+1)-th row of superblocks to a (2*M)-th row of superblocks of the image frame, and to update the CDF table correspondingly during the encoding process of each superblock, wherein a first core circuit of the M core circuits uses the CDF table generated during the encoding process of a last superblock of the first row of superblocks to encode a first superblock of the (M+1)-th row of superblocks.

According to one embodiment of the present invention, an

encoding method comprises the steps of: encoding a first row of superblocks to a M-th row of superblocks in an image frame, respectively; and during an encoding process of each superblock, updating a cumulative distribution function (CDF) table correspondingly for use by a next superblock during encoding; and encoding a (M+1)-th row of superblocks to a (2*M)-th row of superblocks in the image frame, respectively; and during the encoding process of each superblock, updating the CDF table correspondingly, wherein a step of the encoding a first superblock of the (M+1)-th row of superblocks uses the CDF table generated during the encoding process of a last superblock of the first row of superblocks.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an encoder according to an embodiment of the present invention.

FIG. 2 is a flowchart of the encoding process for a row of superblocks in image data according to an embodiment of the present invention.

FIG. 3 is a schematic diagram of an encoding circuit encoding multiple superblocks according to a first embodiment of the present invention.

FIG. 4 is a schematic diagram of an encoding circuit encoding multiple superblocks according to a second embodiment of the present invention.

FIG. 5 is a schematic diagram of an encoding circuit encoding multiple superblocks according to a third embodiment of the present invention.

FIG. 6 is a flowchart of the signal processing method of an encoder according to an embodiment of the present invention.

### DETAILED DESCRIPTION

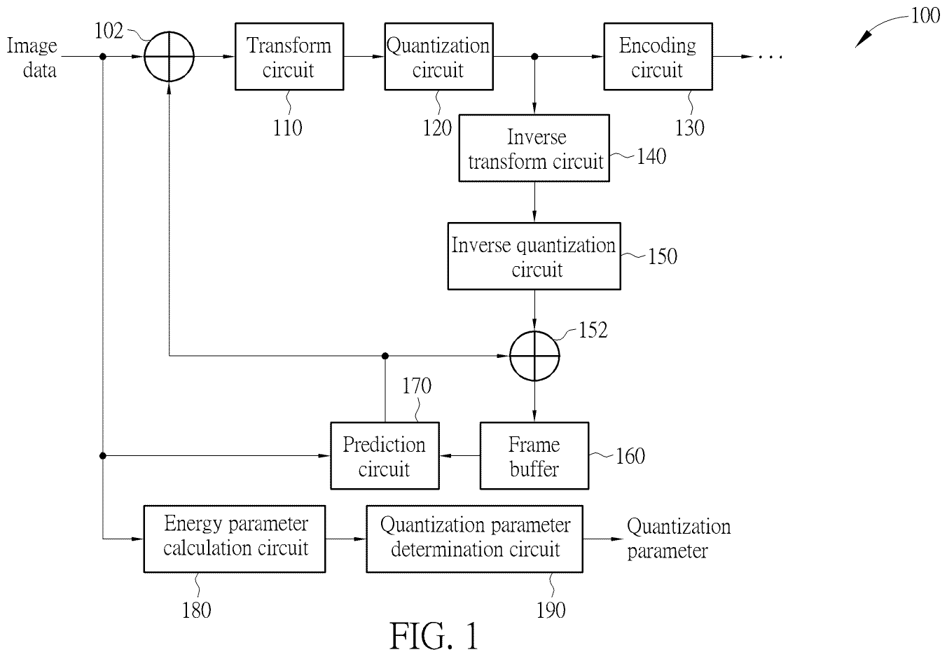

FIG. 1 is a schematic diagram of an encoder 100 according to an embodiment of the present invention. As shown in FIG. 1, the encoder 100 includes a calculation circuit 102, a transform circuit 110, a quantization circuit 120, an encoding circuit 130, an inverse quantization circuit 140, an inverse transform circuit 150, a calculation circuit 152, a frame buffer 160, a prediction circuit 170, an energy parameter calculation circuit 180, and a quantization parameter determination circuit 190. In this embodiment, the encoder 100 supports the AV1 video encoding format established by the Alliance for Open Media (AOMedia), but the present invention is not limited to this.

In the main operation of the encoder 100, the prediction circuit 170 is used to receive external image data (image frames) and interpolated frames or adjusted image data generated internally by the encoder 100, in order to generate predicted image data. The calculation circuit 102 subtracts the predicted image data generated by the prediction circuit 170 from the image data to obtain residual error data. Specifically, the prediction circuit 170 can first divide the received image frame into multiple blocks and perform inter-frame prediction, intra-frame prediction, motion estimation, and/or motion compensation on these blocks to generate predicted image data. This predicted data is then used by the calculation circuit 102 to calculate residual error data corresponding to each of the blocks. Then, the transform circuit 110 performs Discrete Cosine Transform (DCT) operation on the multiple residual error data to convert the data into frequency-domain data. The quantization circuit 120 then performs a quantization operation on the frequency-domain data generated by the transform circuit 110 to generate quantized data, where the quantization operation for each image frame corresponds to a quantization parameter. The quantized data is subsequently processed by the encoding circuit 130 to generate encoded data, which is then transmitted through the backend channel to a decoder (not shown). In addition, the inverse quantization circuit 140 performs an inverse quantization operation on the quantized data generated by the quantization circuit 120, and the inverse transform circuit 150 performs an inverse transform operation (inverse DCT) on the output of the inverse quantization circuit 140 to generate inverse-transformed residual error data. The calculation circuit 152 then adds the inverse-transformed residual error data generated by the inverse transform circuit 150 to the predicted image data generated by the prediction circuit 170, to generate adjusted image data, which is stored in the frame buffer 160 for use by the prediction circuit 170. Furthermore, the energy parameter calculation circuit 180 is used to determine the energy parameter for each block, which is then used by the quantization parameter determination circuit 190 to determine the quantization parameter.

It should be noted that the main operations of the calculation circuit 102, transform circuit 110, quantization circuit 120, encoding circuit 130, inverse quantization circuit 140, inverse transform circuit 150, calculation circuit 152, frame buffer 160, and prediction circuit 170 in the encoder 100 are well known to a person skilled in the art. The detailed operations of the energy parameter calculation circuit 180 and the quantization parameter determination circuit 190 can be referenced in the U.S. patent application (Publication No. US2024/0267528). Since the key technical content of the present invention lies in the operation of the encoding circuit 130, the details of the aforementioned components are omitted here.

In the AV1 video encoding format, multiple coding units of different sizes are defined. The largest coding unit is referred to as a superblock, coding tree unit (CTU), or largest coding unit (LCU), with sizes typically being 128×128 pixels or 64×64 pixels. In the following embodiments, the term “superblock” is used to refer to these units.

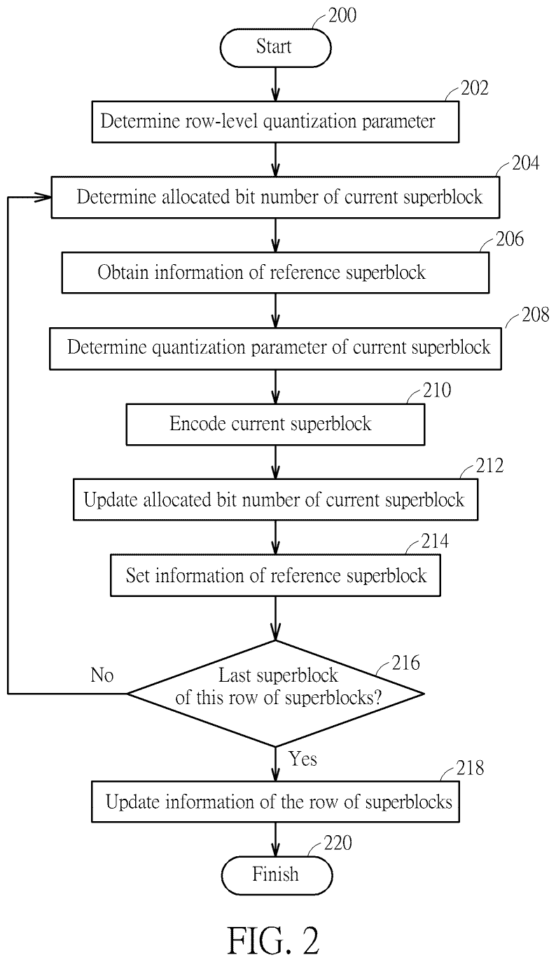

FIG. 2 is a flowchart of encoding a row of superblocks in image data (image frame) according to an embodiment of the present invention. In Step 200, the flow starts. In Step 202, the encoder 100 determines the row-level quantization parameter. In Step 204, the encoder 100 begins processing each superblock in the row of superblocks sequentially. For the current superblock (currently processed block), the encoder 100 determines the allocated bit number for this superblock according to the bit budget (or remaining bits) of the row of superblocks. In Step 206, the encoder 100 obtains information of a reference superblock for the current superblock, such as the estimated bit number for the surrounding superblocks, the encoding mode, or the quantization parameter, etc. In Step 208, the encoder 100 determines the quantization parameter for the current superblock according to the information of the reference superblock and the allocated bit number for the current superblock. In Step 210, the encoder 100 encodes the current superblock, for example, using Context-based Adaptive Binary Arithmetic Coding (CABAC), to generate encoded data. In Step 212, the encoder 100 uses the encoded data to update the allocated bit number for the current superblock. In Step 214, the encoder 100 sets the information of the reference superblock according to encoded information of the current superblock for use by subsequent superblocks. In Step 216, the encoder 100 determines if the current superblock is the last superblock of the row (e.g., the rightmost superblock). If it is, the flow enters Step 218; and if not, the flow goes back to Step 204 to process the next row of superblocks. In Step 218, the encoder 100 updates the row-level information, such as the remaining bits of the row of superblocks. In Step 220, the flow ends, and the encoder 100 begins processing another row of superblocks.

Since the focus of the present invention lies in the process of encoding the superblock in step S210 and the subsequent Steps 212 and 214 in FIG. 2, and since the other steps are well known to a person skilled in the art, the following will primarily describe the contents of Steps 210, 212 and 214.

In the prior art of AV1 video encoding, the CABAC encoding model used in the encoding process encodes the current superblock through a Cumulative Distribution Function (CDF) table. During the encoding of the current superblock, the contents of the CDF table are updated for use in encoding the next superblock. However, since the CABAC encoding model performs encoding on a row-by-row basis, encoding the superblocks sequentially and updating the CDF table, the prior art encounters two main issues during bitrate control. The first issue is that the CABAC encoding model uses the CDF table updated by the previous superblock during its encoding process. Therefore, when implementing multi-core parallel processing, problems arise with the use and updating of the CDF table. The second issue is that the encoding process in the encoder 100 is performed through different modules (hardware circuit modules) in a pipeline manner, and the CABAC encoding module may be separated by several modules from the quantization parameter determination module. This leads to a situation where, during the quantization parameter determination for the current superblock (i.e., Step 208), the encoding of the previous superblock has not yet been completed, resulting in the inability to provide relevant information of reference superblock (i.e., Step 206) for the current superblock to determine the quantization parameters. Therefore, the present invention provides the following embodiments to solve these two issues.

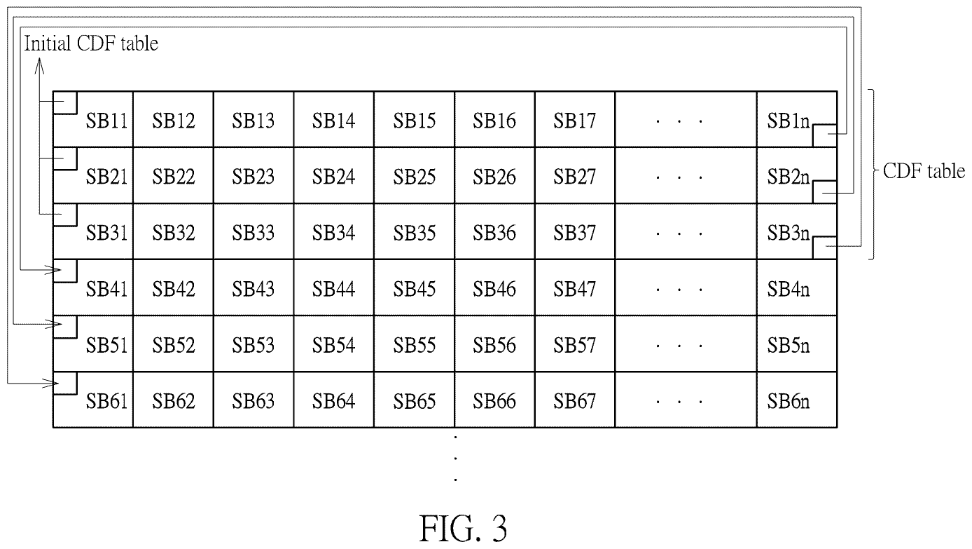

FIG. 3 is a schematic diagram of the encoding circuit 130 encoding multiple superblocks according to a first embodiment of the present invention. As shown in FIG. 3, the image data (image frame) includes multiple rows of superblocks, where the first row of superblocks includes SB11-SB1n, the second row of superblocks includes SB21-SB2n, the third row of superblocks includes SB31-SB3n, the fourth row of superblocks includes SB41-SB4n, the fifth row of superblocks includes SB51-SB5n, the sixth row of superblocks includes SB61-SB6n, and so on, where n is any suitable positive integer. In this embodiment, the encoding circuit 130 has multiple core circuits (e.g., a hardware pseudo binary-to-bit (bin2bit) engine) to simultaneously encode multiple rows of superblocks. For convenience, the description below assumes that three core circuits encode three rows of superblocks simultaneously. Specifically, the three core circuits of the encoding circuit 130 parallelly encode the first, second, and third rows of superblocks, meaning that each core circuit independently encodes the first row of superblocks SB11-SB1n, the second row of superblocks SB21-SB2n, and the third row of superblocks SB31-SB3n, respectively. For the first row of superblocks SB11-SB1n, the first core circuit of the encoding circuit 130 uses an initial CDF table to encode the superblock SB11, and during the encoding process, updates the initial CDF table to generate an updated CDF table for subsequent use. It is important to note that since a superblock can be further divided into multiple blocks (optional, not necessarily), the encoding circuit 130 may update the CDF table multiple times during the encoding process of the superblock, depending on the encoding progress. Next, the first core circuit of the encoding circuit 130 encodes the superblock SB12 based on the updated CDF table, updates the CDF table, then encodes the superblock SB13 and updates the CDF table, and so on, until the encoding and CDF table update for superblock SB1n is completed. After processing the first row of superblocks and completing the CDF table update during the encoding of superblock SB1n, the first core circuit directly uses the updated CDF table obtained during the encoding of SB1n to encode the first superblock SB41 of the fourth row of superblocks, generating another updated CDF table for subsequent use when encoding superblock SB42, and so on.

Similarly, the second core circuit of the encoding circuit 130 uses the initial CDF table to encode the superblock SB21 and update the CDF table, then encodes superblock SB22 and updates the CDF table, and so on, until encoding superblock SB2n and completing the CDF table update. After processing the second row of superblocks and completing the CDF table update during the encoding of superblock SB2n, the second core circuit directly uses the updated CDF table generated during the encoding of SB2n to encode the first superblock SB51 of the fifth row of superblocks, generating another updated CDF table for subsequent use when encoding superblock SB52, and so on.

Similarly, the third core circuit of the encoding circuit 130 uses the initial CDF table to encode the superblock SB31 and update the CDF table, then encodes superblock SB32 and updates the CDF table, and so on, until encoding superblock SB3n and completing the CDF table update. After processing the third row of superblocks and completing the CDF table update during the encoding of superblock SB3n, the third core circuit directly uses the updated CDF table generated during the encoding of SB3n to encode the first superblock SB61 of the sixth row of superblocks, generating another updated CDF table for subsequent use when encoding superblock SB62, and so on.

In the embodiment of FIG. 3, by using multiple core circuits to independently and parallelly process multiple rows of superblocks, the issue in the prior art where the first superblock SB21 of the second row needs to refer the CDF table updated during the encoding of the first row of superblocks is resolved. This approach accelerates the encoding process and achieves effective bitrate control.

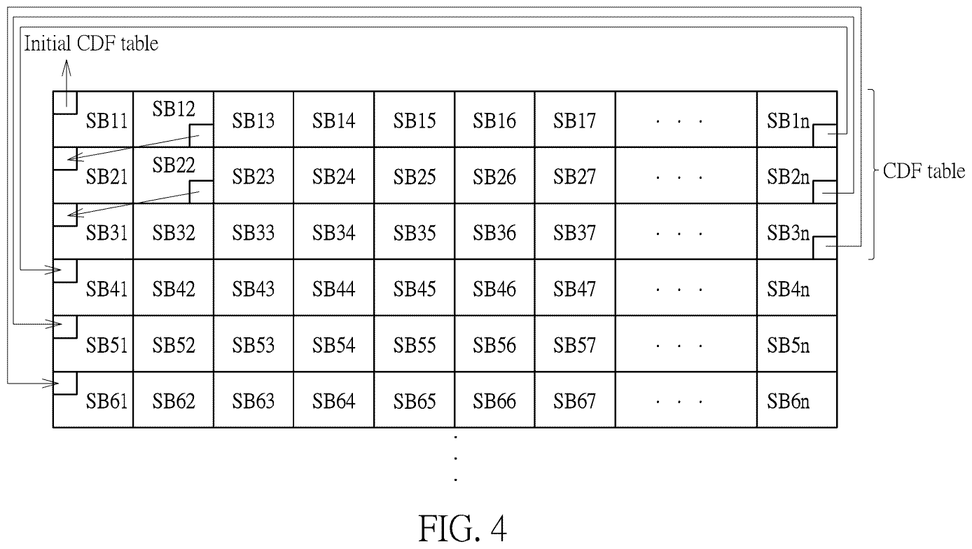

FIG. 4 is a schematic diagram of the encoding circuit 130 encoding multiple superblocks according to a second embodiment of the present invention. Similar to the embodiment in FIG. 3, the encoding circuit 130 has multiple core circuits to simultaneously encode multiple rows of superblocks. For example, the three core circuits of the encoding circuit 130 parallelly encode the first, second, and third rows of superblocks, meaning that each core circuit independently encodes the first row of superblocks SB11-SB1n, the second row of superblocks SB21 SB2n, and the third row of superblocks SB31-SB3n. The embodiment in FIG. 4 is similar to that of FIG. 3, with the difference being that the CDF table used by the second core circuit when encoding superblock SB21 is the CDF table updated by the first core circuit when encoding superblock SB12, rather than the initial CDF table. Similarly, the CDF table used by the third core circuit when encoding superblock SB31 is the CDF table updated by the second core circuit when encoding superblock SB22, rather than the initial CDF table. Through the embodiment in FIG. 4, the encoding circuit 130 ensures that the bit number (or named as bit count) statistically determined during the encoding of multiple superblocks is closer to the actual output bit number, which helps prevent significant deviations that would affect bitrate control.

It should be noted that in the embodiment of FIG. 4, since the CDF table used for encoding superblock SB21 is the CDF table updated during the encoding of superblock SB12, the second core circuit will be behind the first core circuit in terms of the starting time for encoding the second row of superblocks. For example, it may be delayed by about 2 to 3 superblock encodings. Similarly, because the CDF table used for encoding superblock SB31 is the CDF table updated during the encoding of superblock SB22, the third core circuit will be behind the second core circuit in terms of the starting time for encoding the third row of superblocks. For example, it may also be delayed by about 2 to 3 superblock encodings.

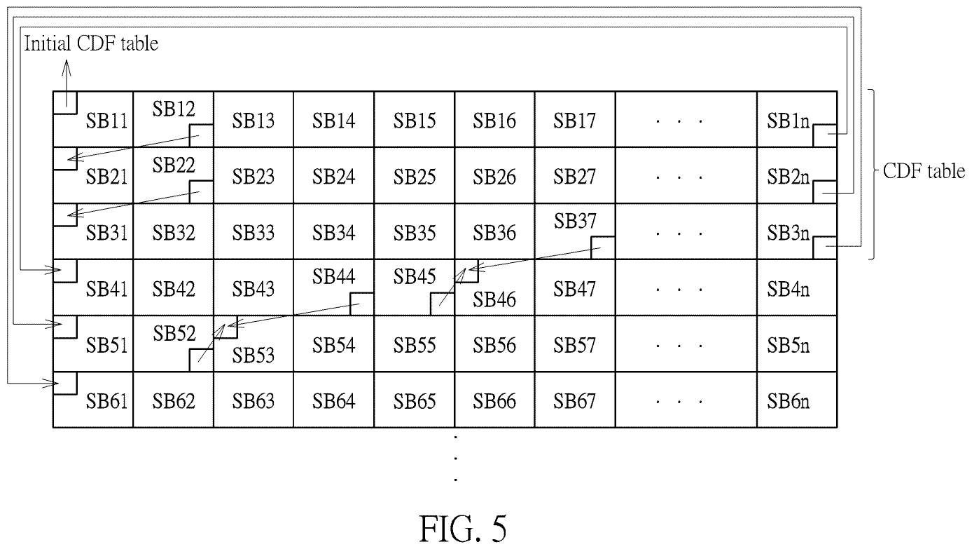

FIG. 5 is a schematic diagram of the encoding circuit 130 encoding multiple superblocks according to a third embodiment of the present invention. Similar to the embodiment in FIG. 4, the encoding circuit 130 has multiple core circuits to simultaneously encode multiple rows of superblocks. For example, the three core circuits of the encoding circuit 130 parallelly encode the first, second, and third rows of superblocks, meaning that each core circuit independently encodes the first row of superblocks SB11-SB1n, the second row of superblocks SB21-SB2n, and the third row of superblocks SB31-SB3n. The embodiment in FIG. 5 is similar to that of FIG. 4, with the difference being that for superblocks located in the middle areas of the fourth row or subsequent rows of superblocks (e.g., non-first superblock and non-last superblock), the encoding process refers both CDF tables of the left-side and upper-right superblocks updated during their respective encoding processes. For example, in the case of superblock SB46 in the fourth row, the CDF table used during its encoding can be obtained by combining a first updated CDF table generated when encoding superblock SB45 and a second updated CDF table generated when encoding superblock SB37. For example, The CDF table used for superblock SB46 can be obtained by performing a weighted or simple averaging operation on the above-mentioned first updated CDF table and the second updated CDF table. In another example, the CDF table used during the encoding of superblock SB53 can be obtained by combining the first updated CDF table generated during the encoding of superblock SB52 and the second updated CDF table generated during the encoding of superblock SB44. Through the embodiment in FIG. 5, the encoding circuit 130 ensures that the bit number statistically determined during the encoding of multiple superblocks is even closer to the actual output bit number, thereby minimizing the impact on bitrate control.

It should be noted that in the embodiment of FIG. 5, since the CDF table used during the encoding of superblock SB53 is obtained by combining the first updated CDF table generated during the encoding of superblock SB52 and the second updated CDF table generated during the encoding of superblock SB44, the second core circuit will be behind the first core circuit in terms of the starting time for encoding the fifth row of superblocks. For example, it may be delayed by about 2 to 3 superblock encodings. Similarly, the third core circuit will be behind the second core circuit in terms of the starting time for encoding the sixth row of superblocks. For example, it may also be delayed by about 2 to 3 superblock encodings.

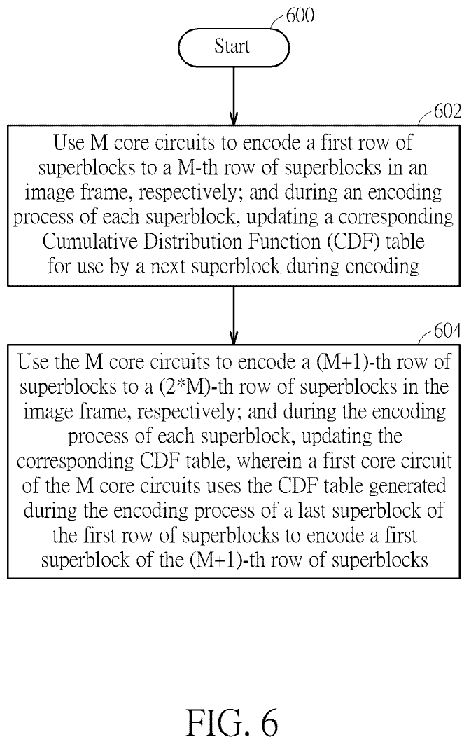

FIG. 6 is a flowchart of the signal processing method of the encoder according to an embodiment of the present invention. Referring simultaneously to the embodiments of FIG. 3 to FIG. 5, the flow is described as follows:
Step 600: the flow starts.
Step 602: use M core circuits to encode a first row of superblocks to a M-th row of superblocks in an image frame, respectively; and during an encoding process of each superblock, updating a corresponding Cumulative Distribution Function (CDF) table for use by a next superblock during encoding.
Step 604: use the M core circuits to encode a (M+1)-th row of superblocks to a (2*M)-th row of superblocks in the image frame, respectively; and during the encoding process of each superblock, updating the corresponding CDF table, wherein a first core circuit of the M core circuits uses the CDF table generated during the encoding process of a last superblock of the first row of superblocks to encode a first superblock of the (M+1)-th row of superblocks.

In one embodiment, the M core circuits use the CDF tables generated during the encoding process of the last superblocks of the first row of superblocks to the M-th row of superblocks, to encode the first superblocks of the (M+1)-th row of superblocks to the (2*M)-th row of superblocks, respectively.

In one embodiment, the second core circuit to the M-th core circuit of the M core circuits use the CDF tables generated during the encoding process of second superblocks in the first row of superblocks to the (M−1)-th row of superblocks, to encode the first superblock of the second row of superblocks to the M-th row of superblocks, respectively.

In one embodiment, for a B-th superblock in the A-th row of superblocks within the (M+1)-th to (2*M)-th row of superblocks, and the B-th superblock is neither the first superblock nor the last superblock, the corresponding core circuit encodes the B-th superblock in the A-th row of superblocks according to a first updated CDF table generated during the encoding process of the (B+1)-th superblock in the (A−1)-th row of superblocks and a second updated CDF table generated during the encoding process of the (B−1)-th superblock in the A-th row of superblocks, wherein A and B are positive integers.

On the other hand, since the current superblock needs to use information from the previous superblock (i.e., the encoded information of the reference superblock as mentioned in Step 206) to determine the quantization parameters, for example, superblock B13 requires the encoded information of superblock B12 when determining its quantization parameters. However, as the previous superblock may not be finished encoding yet, this could cause a delay in determining the quantization parameter for the current superblock. To solve this problem, in this embodiment, Step 206 will use default information as the information of the reference superblock to allow the current encoding superblock to determine the quantization parameter adjustments. For instance, in the reference superblock's information in Step 206, the encoded bit number is derived from the bit allocation in step 204 rather than the actual encoded bit number. Therefore, after the encoder circuit 130 obtains the binary data of the reference superblock, it first uses a bin2bit table to convert it into an estimated bit number. Once the reference superblock finishes encoding and the actual encoded bit number is available, the information for the reference superblock is updated. That is, in Step 212 of FIG. 2, after the current superblock finishes encoding, the encoder 100 will use the encoded data to update the bit allocation for the current superblock. Then, in Step 214, the encoder 100 will set the information of the reference superblock based on the encoded data of the current superblock, which will be used by subsequent superblocks.

As described in the above embodiment, by using the encoding process of the present invention and the mechanism for utilizing the CDF table, the encoding circuit can employ multiple core circuits to parallel-process multiple rows of superblocks. This approach accelerates the encoding process and achieves effective bitrate control.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An encoder, comprising:
M core circuits, configured to encode a first row of superblocks to a M-th row of superblocks of an image frame, and to update a cumulative distribution function (CDF) table correspondingly during an encoding process of each superblock, where M is a positive integer greater than 1; and further configured to encode a (M+1)-th row of superblocks to a (2*M)-th row of superblocks of the image frame, and to update the CDF table correspondingly during the encoding process of each superblock, wherein a first core circuit of the M core circuits uses the CDF table generated during the encoding process of a last superblock of the first row of superblocks to encode a first superblock of the (M+1)-th row of superblocks.

2. The encoder of claim 1, wherein the M core circuits are configured to encode the first row of superblocks to the M-th row of superblocks of the image frame in parallel, and to encode the (M+1)-th row of superblocks to the (2*M)-th row of superblocks of the image frame in parallel.

3. The encoder of claim 1, wherein the M core circuits use multiple CDF tables generated during the encoding process of the last superblocks in the first row of superblocks to the M-th row of superblocks, to encode the first superblock of the (M+1)-th row of superblocks to the (2*M)-th row of superblocks, respectively.

4. The encoder of claim 3, wherein the M core circuits use an initial CDF table to encode the first superblocks of the first row of superblocks to the M-th row of superblocks.

5. The encoder of claim 3, wherein a second core circuit to the M-th core circuit of the M core circuits use the CDF tables generated during the encoding process of second superblocks in the first row of superblocks to the (M−1)-th row of superblocks, to encode the first superblock of the second row of superblocks to the M-th row of superblocks, respectively.

6. The encoder of claim 3, wherein for a B-th superblock in the A-th row of superblocks within the (M+1)-th to (2*M)-th row of superblocks, and the B-th superblock is neither the first superblock nor the last superblock, the corresponding core circuit encodes the B-th superblock in the A-th row of superblocks according to a first updated CDF table generated during the encoding process of the (B+1)-th superblock in the (A−1)-th row of superblocks and a second updated CDF table generated during the encoding process of the (B−1)-th superblock in the A-th row of superblocks, wherein A and B are positive integers.

7. The encoder of claim 6, wherein the CDF table used for encoding the B-th superblock in the A-th row of superblock is obtained by performing a weighted averaging or averaging operation on the first updated CDF table and the second updated CDF table.

8. The encoder of claim 1, wherein the encoder supports an AV1 video coding format defined by Alliance for Open Media (AOMedia).

9. An encoding method of an encoder, comprising:
encoding a first row of superblocks to a M-th row of superblocks in an image frame, respectively, where M is a positive integer greater than 1; and during an encoding process of each superblock, updating a cumulative distribution function (CDF) table correspondingly for use by a next superblock during encoding; and
encoding a (M+1)-th row of superblocks to a (2*M)-th row of superblocks in the image frame, respectively; and during the encoding process of each superblock, updating the CDF table correspondingly, wherein a step of the encoding a first superblock of the (M+1)-th row of superblocks uses the CDF table generated during the encoding process of a last superblock of the first row of superblocks.

10. The encoding method of claim 9, wherein the step of encoding the first row of superblocks to the M-th row of superblocks in an image frame, respectively, and the step of encoding the (M+1)-th row of superblocks to the (2*M)-th row of superblocks in the image frame, respectively, comprises:
encoding the first row of superblocks to the M-th row of superblocks of the image frame in parallel; and
encoding the (M+1)-th row of superblocks to the (2*M)-th row of superblocks of the image frame in parallel.

11. The encoding method of claim 9, wherein the step of encoding the (M+1)-th row of superblocks to the (2*M)-th row of superblocks in the image frame, respectively, comprises:
using multiple CDF tables generated during the encoding process of the last superblocks in the first row of superblocks to the M-th row of superblocks, to encode the first superblock of the (M+1)-th row of superblocks to the (2*M)-th row of superblocks, respectively.

12. The encoding method of claim 11, wherein the step of encoding the first row of superblocks to the M-th row of superblocks in an image frame, respectively, comprises:
using an initial CDF table to encode the first superblocks of the first row of superblocks to the M-th row of superblocks.

13. The encoding method of claim 11, wherein the step of encoding the (M+1)-th row of superblocks to the (2*M)-th row of superblocks in the image frame, respectively, comprises:
using the CDF tables generated during the encoding process of second superblocks in the first row of superblocks to the (M−1)-th row of superblocks, to encode the first superblock of the second row of superblocks to the M-th row of superblocks, respectively.

14. The encoding method of claim 11, wherein the step of encoding the (M+1)-th row of superblocks to the (2*M)-th row of superblocks in the image frame, respectively, comprises:
for a B-th superblock in the A-th row of superblocks within the (M+1)-th to (2*M)-th row of superblocks, and the B-th superblock is neither the first superblock nor the last superblock, encoding the B-th superblock in the A-th row of superblocks according to a first updated CDF table generated during the encoding process of the (B+1)-th superblock in the (A−1)-th row of superblocks and a second updated CDF table generated during the encoding process of the (B−1)-th superblock in the A-th row of superblocks, wherein A and B are positive integers.

15. The encoding method of claim 14, wherein the CDF table used for encoding the B-th superblock in the A-th row of superblock is obtained by performing a weighted averaging or averaging operation on the first updated CDF table and the second updated CDF table.
